(19) United States
(12) Patent Application Publication
(10) Pub. No.: US 2026/0186873 A1
(43) Pub. Date: Jul. 2, 2026

(54) APPLICATION RENDERING METHOD AND DEVICE, STORAGE MEDIUM, AND PROGRAM PRODUCT

(71) Applicant: Beijing Zitiao Network Technology Co., Ltd., Beijing (CN)

(72) Inventors: Zhaoyu LIU, Beijing (CN); Qi LIU, Beijing (CN); Zaishang WANG, Beijing (CN)

(21) Appl. No.: 19/333,132

(22) Filed: Sep. 18, 2025

(30) Foreign Application Priority Data
Jan. 2, 2025 (CN) 202510006558.9

(51) Int. Cl. G06F 9/54; G06F 9/52

(52) U.S. Cl. CPC G06F 9/542; G06F 9/522

(57) ABSTRACT

The embodiments of the present disclosure provide an application rendering method and device, storage medium, and program product, the method comprising: when it is detected that a focused application in a display interface is operated, judging whether there are non-focused applications displayed in the same interface in the display interface; if there are the non-focused applications in the display interface, determining the priorities of rendering instruction queues corresponding to the focused application and the respective non-focused applications; if the priority of the rendering instruction queue of the focused application is not higher than the priorities of the rendering instruction queues of the non-focused applications, adjusting the priority corresponding to the focused application to be higher than the priorities corresponding to all the non-focused applications; transmitting the rendering instructions in the rendering instruction queue of the focused application to the graphics processor according to the adjusted target priority, so that the graphics processor preferentially executes the rendering instructions of the focused application according to the target priority.

### CROSS-REFERENCE TO RELATED APPLICATIONS

The present application claims the benefit of priority to the Chinese patent application No. 202510006558.9 filed with Chinese Patent Office on Jan. 2, 2025, which is hereby incorporated by reference in its entirety into the present application.

### TECHNICAL FIELD

Embodiments of the present disclosure relate to the GPU graphics rendering technical field, and in particular an application rendering method and device, storage medium, and program product.

### BACKGROUND

For electronic devices such as mobile phones, Extended Reality (XR) devices, Virtual Reality (VR) devices, displaying applications in these devices in windows needs to use Graphics Processing Unit (GPU) resources to render images.

In various usage scenarios, it often happens in the above-mentioned electronic device that multiple applications are opened at the same time, and the application windows overlap or are tiled. At this time, each application will consume GPU resources.

However, in the case where there are many application windows, the application operated by the user will be allocated fewer GPU resources, which leads to the problem of interaction lags when the user operates the application.

### SUMMARY

Embodiments of the present disclosure provide an application rendering method and device, storage medium and program product, so as to overcome the problem of lags of the application operated by the user due to insufficient allocation of GPU resources when multiple application windows coexist.

In a first aspect, an embodiment of the present disclosure provides an application rendering method applied to an electronic device which comprises a graphics processor, the method comprising: when it is detected that a focused application in a display interface is operated, judging whether there are non-focused applications displayed in the same interface in the display interface; if there are the non-focused applications in the display interface, determining the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue is preferentially executed by the graphics processor; if the priority of the rendering instruction queue of the focused application is not higher than the priorities of the rendering instruction queues of the non-focused applications, adjusting the priority corresponding to the focused application to be higher than the priorities corresponding to all the non-focused applications; transmitting the rendering instructions in the rendering instruction queue of the focused application to the graphics processor according to the adjusted target priority, so that the graphics processor preferentially executes the rendering instructions of the focused application according to the target priority.

In a second aspect, an embodiment of the present disclosure provides an application rendering device, comprising: an application judgement module for judging, when it is detected that a focused application in a display interface is operated, whether there are non-focused applications displayed in the same interface in the display interface; a priority determination module for determining, if there are the non-focused applications in the display interface, the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue are preferentially executed by the graphics processor; a priority adjustment module for adjusting, if the priority of the rendering instruction queue of the focused application is not higher than the priorities of the rendering instruction queues of the non-focused applications, the priority corresponding to the focused application to be higher than the priorities corresponding to all the non-focused applications; an instruction sending module for transmitting the rendering instructions in the rendering instruction queue of the focused application to the graphics processor according to the adjusted target priority, so that the graphics processor preferentially executes the rendering instructions of the focused application according to the target priority.

In a third aspect, an embodiment of the present disclosure provides an electronic device including: a processor and a memory;
the memory stores computer-executable instructions;
the processor executes the computer-executable instructions stored in the memory, so that the at least one processor executes the application rendering method according to the above-mentioned first aspect and various possible designs of the first aspect.

In a fourth aspect, an embodiment of the present disclosure provides a computer-readable storage medium, in which computer-executable instructions are stored, and when executed by a processor, implement the application rendering method according to the above-mentioned first aspect and various possible designs of the first aspect.

In a fifth aspect, an embodiment of the present disclosure provides a computer program product, including computer programs, which, when executed by a processor, implement the application rendering method according to the above-mentioned first aspect and various possible designs of the first aspect.

According to the application rendering method and apparatus, storage medium and program product provided by the embodiments, by determining the priorities of the rendering instruction queues corresponding to the respective applications in the display interface when it is detected that a focused application is operated and there are non-focused applications, adjusting the priority corresponding to the focused application to be higher than the priorities of the non-focused applications, and transmitting the rendering instruction corresponding to the focused application to the graphics processor according to the adjusted target priority, the graphics processor preferentially executes the rendering instructions of the focused application.

### BRIEF DESCRIPTION OF DRAWINGS

In order to explain the embodiments of the present disclosure or the technical solutions in the related art more clearly, the drawings needed in the description of the embodiments or the related art will be briefly introduced below. Obviously, the drawings in the following description are some embodiments of the present disclosure, and those skilled in the art do not require inventive effort to obtain other drawings according to these drawings.

FIG. 1 is a schematic diagram of an application scenario of an application rendering method provided by an embodiment of the present application;

FIG. 2 is a schematic flow diagram of an application rendering method provided by an embodiment of the present disclosure;

FIG. 3 is a schematic diagram of a relationship between rendering instruction queues and execution queues provided by an embodiment of the present application;

FIG. 4 is a schematic diagram of a data distribution process of a rendering instruction queue, into which a barrier identification is written, provided by an embodiment of the present application;

FIG. 5 is a schematic structural diagram of an application rendering device provided by an embodiment of the present application;

FIG. 6 is a schematic structural diagram of an electronic device provided by an embodiment of the present application.

### DETAILED DESCRIPTION

In order to make the purpose, technical solutions and advantages of the embodiments of the present disclosure more clear, the technical solutions in the embodiments of the present disclosure will be described clearly and completely in combination with the attached drawings in the embodiments of the present disclosure. Obviously, the described embodiments are a portion of the embodiments of the disclosure, but not all the embodiments. Based on the embodiments in the present disclosure, all other embodiments obtained by those skilled in the art without inventive effort belong to the protection scope of the present disclosure.

Applications in electronic devices such as mobile phones, XR devices and VR devices all rely on GPU resources to render images in windows.

In an actual usage process, these electronic devices often run multiple applications at the same time, resulting in overlapped or tiled display of various application windows. At this point, each application will occupy GPU resources.

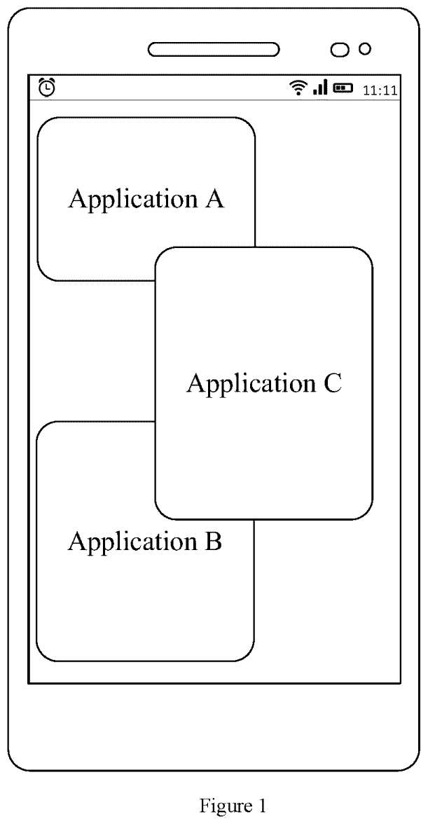

FIG. 1 is a schematic diagram of an application scenario of an application rendering method provided by an embodiment of the present application. As shown in FIG. 1, the electronic device displays an interface with three applications displayed at the same time. When the user is operating application C, application C becomes a focused application, where the GPU preferentially renders images of application C.

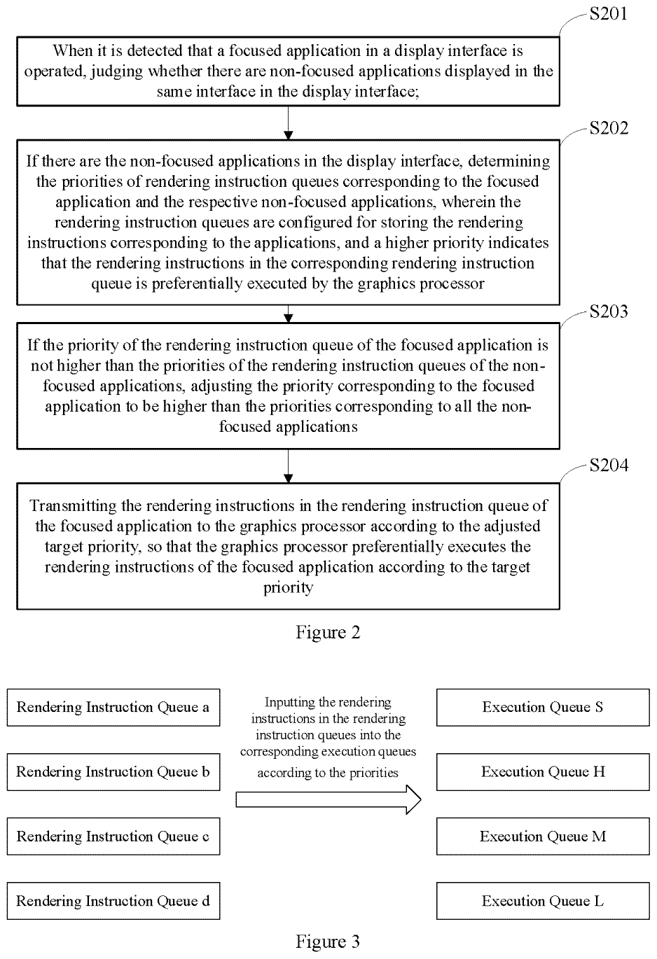

Referring to FIG. 2, FIG. 2 is a schematic flow diagram of an application rendering method provided by an embodiment of the present disclosure. The method of the present embodiment can be applied to an electronic device, which includes a graphics processor, and the application rendering method includes:
S201: when it is detected that a focused application in a display interface is operated, judging whether there are non-focused applications displayed in the same interface in the display interface.

In this step, the focused application in the display interface can be an application selected by the user or an application that the user is watching (the application that the user is watching can be judged in a detection way preset in VR devices, AR devices or XR devices). To judge whether there are non-focused applications displayed in the same interface in the display interface, it is possible to call an interface to obtain identifications of the application windows displayed in the display interface, and determine whether there are non-focused applications displayed in the same interface according to the number of identifications of application windows. Specifically, if the number of identifications is greater than or equal to 2, it is judged that there are non-focused applications.

S202: if there are the non-focused applications in the display interface, determining the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue are preferentially executed by the graphics processor.

In this step, the determining the priorities of rendering instruction queues corresponding to the focused application and the respective non-focused applications can be realized by reading priority attribute of the rendering instruction queue corresponding to each of the focused application and non-focused applications. The rendering instructions can be generated by the application according to the user's operation.

S203: if the priority of the rendering instruction queue of the focused application is not higher than the priorities of the rendering instruction queues of the non-focused applications, adjusting the priority corresponding to the focused application to be higher than the priorities corresponding to all the non-focused applications.

In this step, for example, the priority corresponding to the focused application is a medium priority and the priority corresponding to an non-focused application is a high priority, then the priority of the non-focused application is lowered to the medium priority and the priority of the focused application is adjusted to the high priority. For another example, if application 1 is a focused application with the corresponding priority low, application 2 is a non-focused application with the corresponding priority medium, and application 3 is a non-focused application with the corresponding priority low, then the corresponding priority of application 1 is adjusted to high.

S204: transmitting the rendering instructions in the rendering instruction queue of the focused application to the graphics processor according to the adjusted target priority, so that the graphics processor preferentially executes the rendering instructions of the focused application according to the target priority.

This step can include preferentially sending the rendering instructions in the rendering instruction queue of the focused application to the GPU, and then sending the rendering instructions corresponding to the non-focused applications, where the GPU sequentially executes the received rendering instructions; or include sending the rendering instructions corresponding to the focused application along with the corresponding priority to the GPU, so that the GPU preferentially executes the rendering instructions of the focused application according to the priority.

As can be seen from the description of the above embodiment, the embodiment of the present disclosure determines the priorities of the rendering instruction queues corresponding to the respective applications in the display interface when it is detected that the focused application is operated and there are non-focused applications, adjusts the priority corresponding to the focused application to be higher than the priorities of the non-focused applications, and transmits the rendering instructions corresponding to the focused application to the GPU according to the adjusted target priority, so that the GPU preferentially executes the rendering instructions of the focused application, thus making the response of the focused application smoother and reducing the lags of the focused application.

In one possible implementation, the GPU maintains a plurality of execution queues, and the priority of the execution queue is corresponding to or consistent with that of the rendering instruction queue, and the execution queue is configured for storing rendering instructions in the rendering instruction queue with a corresponding priority.

FIG. 3 is a schematic diagram of a relationship between the rendering instruction queues and the execution queues provided by an embodiment of the present application. As shown in FIG. 3, the rendering instruction queues corresponding to the respective applications are on the left, and the execution queues are on the right. The electronic device transmits the rendering instructions in the rendering instruction queue according to the priority to the execution queue with the corresponding priority on the right. The priorities of execution queues S, H, M and L on the right decrease in turn, and the GPU will preferentially execute the rendering instructions in the execution queue with a higher priority.

For example, when there are rendering instructions in each of the execution queues S, H and L, the rendering instructions in the execution queue S are executed first, then the rendering instructions in the execution queue H are executed after the execution of the rendering instructions in the execution queue S is completed, and then the rendering instructions in the execution queue L are executed after the execution of the rendering instruction in the execution queue H is completed. When there are rendering instructions in the execution queues H and L, the rendering instructions in the execution queue H are executed first, and then the rendering instructions in the execution queue L are executed.

Accordingly, the above step S204 of transmitting the rendering instructions in the rendering instruction queue of the focused application to the GPU according to the adjusted target priority, so that the GPU preferentially executes the rendering instructions of the focused application according to the target priority includes: step S2041.

S2041: transmitting the rendering instructions in the rendering instruction queue of the focused application to the execution queue corresponding to a target priority, so that the graphics processor preferentially executes the rendering instructions in the execution queue corresponding to the target priority.

In this step, for example, the target priority corresponding to the rendering instruction queue of the focused application is medium and the priority corresponding to the execution queue M is also medium, so the rendering instructions in the rendering instruction queue of the focused application are transmitted to the execution queue M, so that the GPU preferentially executes the rendering instructions of the focused application according to the priority of the execution queue.

As can be seen from the description of the above embodiment, the embodiment of the present disclosure causes the GPU to preferentially execute the rendering instructions in the execution queue with a higher priority by setting execution queues with different priorities in the GPU. Combined with the above embodiment, in which the rendering instructions of the focused application are input into the execution queue with a higher priority, preferential execution of the rendering instructions of the focused application is implemented, improving running smoothness of the focused application.

In one possible implementation, after the above step S203 of adjusting the priority corresponding to the focused application to be higher than the priorities corresponding to all the non-focused applications, the method further includes:
S220: detecting whether there is an unexecuted rendering instruction of the rendering instruction queue of the focused application remaining in the corresponding original execution queues before priority adjustment of the rendering instruction queue of the focused application.

This step can include reading the content in the original execution queues before transmitting the rendering queue to the execution queue with a corresponding priority, so as to judge whether there is an unexecuted rendering instruction of the rendering instruction queue corresponding to the focused application in the content of the execution queues.

S221: if there is no unexecuted rendering instruction of the rendering instruction queue of the focused application remaining in the original execution queues, transmitting the rendering instructions in the rendering instruction queue of the focused application to the execution queue corresponding to the target priority, so that the graphics processor preferentially executes the rendering instructions of the focused application according to the target priority.

In this step, there is no remaining unexecuted rendering instruction of the rendering instruction queue of the focused application, which can include: there is no rendering instruction in the execution queues or there are rendering instructions of applications other than the focused application in the execution queues.

As can be seen from the description of the above embodiments, the embodiment of the present disclosure detects whether there is a rendering instruction corresponding to the focused application in the execution queues before the priority adjustment of the focused application, and then transmits the rendering instructions in the rendering instruction queue of the focused application to the execution queue corresponding to the target priority if there is no rendering instruction corresponding to the focused application, so that resources will not be occupied or conflicted in the rendering process performed by the GPU.

In one possible implementation, the method further includes:
S230: if there is an unexecuted rendering instruction of the rendering instruction queue of the focused application remaining in the original execution queues, adding a barrier identification in the rendering instruction queue of the focused application.

In this step, the process of adding the barrier identification in the rendering instruction queue can include acquiring the identification of the unexecuted rendering instruction and writing the identification of the rendering instruction into a barrier template to obtain the barrier identification, or writing a preset barrier identification into the rendering instruction queue.

S231: acquiring an identification of the rendering instruction remaining in the original execution queue according to the barrier identification, and suspending sending of the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queues is completed, and continuing transmitting the rendering instructions in the rendering instruction queue of the focused application to the execution queue corresponding to the target priority; wherein the barrier identification is associated with the identification of the rendering instruction remaining in the original execution queue.

In this step, when the execution of the rendering instruction remaining in the original execution queue completed, the execution queue no longer includes the remaining rendering instruction. Whether the adjustment of the priority of the focused application is completed can be judged by reading the priority identification of the rendering instruction queue of the focused application. The association of the barrier identification with the identification of the rendering instruction remaining in the original execution queue can be realized by establishing a corresponding relationship between the barrier identification and the identification of the rendering instruction, or by writing the identification of the rendering instruction into the barrier identification.

As can be seen from the description of the above embodiments, the embodiment of the present disclosure adds the barrier identification in the rendering instruction queue so as to prevent the rendering instructions of the focused application from entering the execution queue before the execution of all the rendering instructions of the focused application before the priority adjustment is completed and before the priority adjustment is completed, thus avoiding inconsistency between the execution order and the submission order of the rendering instructions of the focused application, or mutual occupation of resources between the rendering instructions of the focused application, thus ensuring normal execution of the rendering instructions of the focused application.

In one possible implementation, the barrier identification includes a first barrier identification and a second barrier identification. The first barrier identification and the second barrier identification are located at the head of the rendering instruction queue of the focused application.

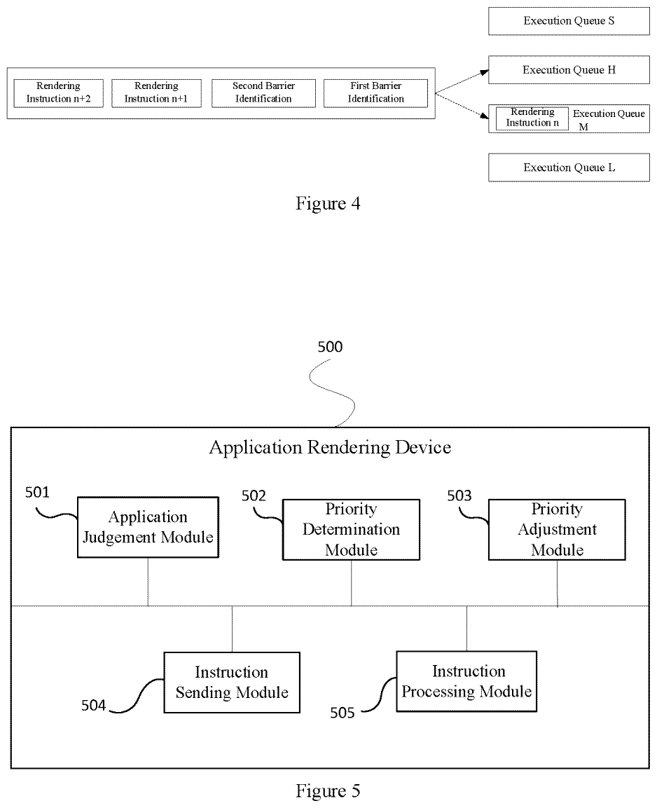

FIG. 4 is a schematic diagram of a data distribution process of a rendering instruction queue, into which a barrier identification is written, provided by an embodiment of the present application. As shown in FIG. 4, a first barrier identification and a second barrier identification are inserted into the head of the rendering instruction queue. Before the barrier identifications are inserted and the priority is changed, the rendering instructions in the rendering instruction queue will be sent to the execution queue M (as shown by the dashed arrow), and after the barrier identifications are inserted and the priority is changed, the rendering instructions in the rendering instruction queue will be sent to the execution queue H (as shown by the solid arrow). When there is a remaining rendering instruction (rendering instruction n in the figure) corresponding to the focused application in the original execution queue M, the rendering instructions (rendering instruction n+1 and rendering instruction n+2 in the figure) in the rendering instruction queue are sent to the execution queue H after the execution of the remaining rendering instruction is completed.

The first barrier identification is configured for instructing to acquire the identification of the rendering instruction remaining in the original execution queue and suspending the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released.

In this step, the step of transmitting the rendering instructions in the rendering instruction queue of the focused application to the execution queue corresponding to the target priority can include the above step S2041. The step of adjusting the priority corresponding to the focused application to be higher than the priorities corresponding to all the non-focused applications can include the above step S203. During the process of sending the rendering instructions in the rendering instruction queue to the execution queue, the data in the rendering instruction queue is read in turn. After reading and sending the first barrier identification to the execution queue maintained by the GPU, the GPU determines whether the priority adjustment process corresponding to the focused application is completed and whether the rendering instructions before the priority adjustment are completed, and reads the subsequent data in the rendering instruction queue if both have been completed,.

The second barrier identification is associated with the identification of the remaining rendering instruction and configured for instructing to suspend the step of transmitting the rendering instructions in the rendering instruction queue of the focused application to the execution queue corresponding to the target priority. The second barrier identification is released after the execution of the remaining rendering instructions is ended, and then the step of transmitting the rendering instructions in the rendering instruction queue of the focused application to the execution queue corresponding to the target priority continues.

In this step, it is possible to associate the second barrier identification with the identification of the remaining rendering instruction by writing the identification of the remaining rendering instruction into the second barrier identification, or by establishing the corresponding relationship between the second barrier identification and the identification of the remaining rendering instruction. After the second barrier identification is sent to the execution queue maintained by the GPU, the GPU detects whether the above-mentioned remaining rendering instruction is still in the execution queue according to the identification of the rendering instruction associated with the second barrier identification, and if not, determines that the execution of the remaining rendering instruction is completed, and releases the second barrier identification.

As can be seen from the description of the above embodiments, the embodiment of the present disclosure adds the first barrier identification and the second barrier identification in the rendering instruction queue so as to realize the detection of the priority adjustment progress and the execution progress of the remaining rendering instruction, and ensure the correctness of the execution order of the rendering instruction.

In one possible implementation, in the above step S203, the adjusting the priority corresponding to the focused application to be higher than the priorities corresponding to all the non-focused applications includes steps S2031 to S2033.

S2031: if the priorities of the respective non-focused applications do not include the highest priority, determining any priority higher than the priorities of all the non-focused applications as the target priority, and adjusting the priority of the focused application as the target priority.

In this step, the priorities of the non-focused applications are the priorities of the rendering instruction queues corresponding to the non-focused applications, and the priority of the focused application is the priority of the rendering instruction queue corresponding to the focused application.

For example, execution queues A, B, C, D and E are arranged from high to low priority, and the priorities of the non-focused applications correspond to execution queues D and E, then any one of the priorities corresponding to execution queues A, B and C can be determined as the target priority, and the target priority can be taken as the priority corresponding to the focused application. For another example, execution queues S, H, M and L are arranged from high to low priority, and the priorities of the non-focused applications correspond to execution queues M and L, then one of the priorities corresponding to execution queues S and H can be selected as the target priority, and the target priority can be taken as the priority corresponding to the focused application.

S2032: if the priorities of the respective non-focused applications include the highest priority and the priority of the focused application is the highest priority, lowering the priorities of the respective non-focused applications.

This step can include lowering the priorities of the respective non-focused applications by N levels, where N is a positive integer, or include lowering the priority of the non-focused application, which is not the lowest priority, by N levels.

For example, if the priorities from high to low are A, B, C, D, E, the priorities corresponding to the no focused applications include A, B, C, and the focused application corresponds to priority A, then the priorities corresponding to the non-focused applications are adjusted to B, C, D or C, D, E. For another example, execution queues S, H, M and L are arranged from high to low priority, and the priorities of the non-focused applications correspond to the execution queues S, H and M, then the priorities of the non-focused applications are adjusted to H, M and L.

S2033: if the priorities of the respective non-focused applications include the highest priority and the priority of the focused application is not the highest priority, lowering the priorities of the respective non-focused applications, and determining the highest priority as the priority of the focused application.

In this step, similar to the above step S2032, if the priority corresponding to any of the non-focused applications is already the lowest, then the priority of this non-focused application will not be lowered further, which can be regarded as the priority of this non-focused application having been lowered.

As can be seen from the description of the above embodiments, the embodiment of the present disclosure comprehensively adjusts the priorities corresponding to the focused application and the non-focused applications, so as to realize that the priority of the focused application is higher than the priorities of the non-focused applications, and also ensures that the priorities among the non-focused applications remain unchanged to the greatest extent.

FIG. 5 is a schematic structural diagram of an application rendering device provided by an embodiment of the present application. As shown in FIG. 5, an application rendering device 500 includes: an application judgement module 501, a priority determination module 502, a priority adjustment module 503 and an instruction sending module 504.

The application judgement module 501 is configured for judging, when it is detected that a focused application in a display interface is operated, whether there are non-focused applications displayed in the same interface in the display interface.

The priority determination module 502 is configured for determining, if there are non-focused applications in the display interface, the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue are preferentially executed by the graphics processor.

The priority adjustment module 503 is configured for adjusting, if the priority of the rendering instruction queue of the focused application is not higher than the priorities of the rendering instruction queues of the non-focused applications, the priority corresponding to the focused application to be higher than the priorities corresponding to all the non-focused applications.

The instruction sending module 504 is configured for transmitting the rendering instructions in the rendering instruction queue of the focused application to the graphics processor according to the adjusted target priority, so that the graphics processor preferentially executes the rendering instructions of the focused application according to the target priority.

In one possible implementation, the graphics processor maintains a plurality of execution queues, and the priorities of the execution queues are corresponding to or consistent with the priorities of the respective rendering instruction queues, and the execution queues are configured for storing rendering instructions in the rendering instruction queues with corresponding priorities. Accordingly, the instruction sending module 504 is specifically configured for: transmitting the rendering instructions in the rendering instruction queue of the focused application to the execution queue corresponding to the target priority, so that the graphics processor preferentially executes the rendering instructions in the execution queue corresponding to the target priority.

In one possible implementation, the application rendering device 500 further includes: an instruction processing module 505.

The instruction processing module 505 is specifically configured for detecting whether there is an unexecuted rendering instruction of the rendering instruction queue of the focused application remaining in the corresponding original execution queue before priority adjustment of the rendering instruction queue of the focused application; if there is no unexecuted rendering instruction of the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

In one possible implementation, the instruction processing module 505 is further configured for adding barrier identification in the rendering instruction queue of the focused application if there is an unexecuted rendering instruction of the rendering instruction queue of the focused application remaining in the original execution queue; acquiring an identification of the rendering instruction remaining in the original execution queue according to the barrier identification, and suspending sending of the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and then continuing transmitting the rendering instructions in the rendering instruction queue of the focused application to the execution queue corresponding to the target priority; wherein the barrier identification is associated with the identification of the rendering instruction remaining in the original execution queue.

In one possible implementation, the barrier identification includes a first barrier identification and a second barrier identification; the first barrier identification and the second barrier identification are located at the head of the rendering instruction queue of the focused application; wherein the first barrier identification is configured for instructing to acquire the identification of the rendering instruction remaining in the original execution queue and suspending the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released; wherein the second barrier identification is associated with the identification of the remaining rendering instruction and is configured for instructing to suspend the step of transmitting the rendering instructions in the rendering instruction queue of the focused application to the execution queue corresponding to the target priority. The second barrier identification is released after the execution of the remaining rendering instruction is ended, and the step of transmitting the rendering instructions in the rendering instruction queue of the focused application to the execution queue corresponding to the target priority continues.

In one possible implementation, the priority adjustment module 503 is specifically configured for determining, if the priorities of the respective non-focused applications do not include the highest priority, any priority higher than the priorities of all the non-focused applications as the target priority, and adjusting the priority of the focused application as the target priority; if the priorities of the respective non-focused applications include the highest priority and the priority of the focused application is the highest priority, lowering the priorities of the respective non-focused applications; if the priorities of the respective non-focused applications include the highest priority and the priority of the focused application is not the highest priority, lowering the priorities of the respective non-focused applications, and determining the highest priority as the priority of the focused application.

The device provided in the present embodiment can be configured for executing the technical solution of the above method embodiment, and has a similar implementation principle and technical effect, so the details of the present embodiment are not repeated here.

In order to implement the above embodiment, an embodiment of the present disclosure also provides an electronic device.

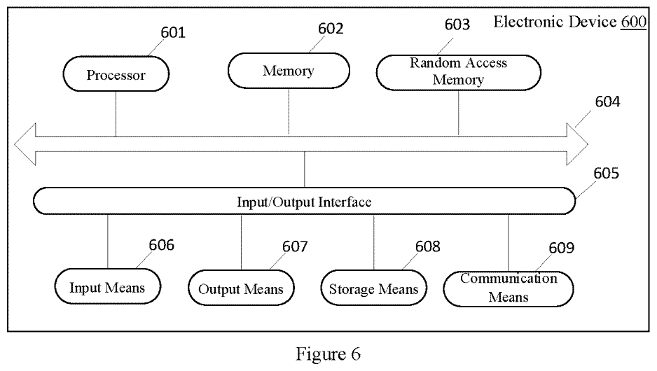

Referring to FIG. 6, it shows a structural schematic diagram of an electronic device 600 suitable for implementing the embodiment of the present disclosure. The electronic device 600 can be a terminal device or a server. The terminal device can include, but is not limited to, mobile terminals such as a mobile phone, a notebook computer, a digital broadcast receiver, a Personal Digital Assistant (PDA), a Portable Android Device (PAD), a portable multimedia player (PMP), a vehicle-mounted terminal (such as a vehicle-mounted navigation terminal), and fixed terminals such as a digital TV and a desktop computer. The electronic device shown in FIG. 6 is just an example, and should not bring any limitation to the function and application scope of the embodiment of the present disclosure.

As shown in FIG. 6, the electronic device 600 can include a processing means (such as a central processor, a graphics processor, etc.) 601, which can perform various appropriate actions and processes according to a program stored in a Read Only Memory (ROM) 602 or a program loaded from a storage means 608 into a Random Access Memory (RAM) 603. In the RAM 603, various programs and data required for the operation of the electronic device 600 are also stored. The processing means 601, the ROM 602 and the RAM 603 are connected to each other through a bus 604. An input/output (I/O) interface 605 is also connected to the bus 604.

Generally, the following means can be connected to the I/O interface 605: an input means 606 including, for example, a touch screen, a touch pad, a keyboard, a mouse, a camera, a microphone, an accelerometer, a gyroscope, etc.; an output means 607 including, for example, a Liquid Crystal Display (LCD), a speaker, a vibrator, etc.; a storage means 608 including, for example, a magnetic tape, a hard disk, etc.; and a communication means 609. The communication means 609 can allow the electronic device 600 to perform wireless or wired communication with other devices to exchange data. Although FIG. 6 shows the electronic device 600 with various means, it should be understood that it is not required to implement or provide all the means shown. More or fewer means can alternatively be implemented or provided.

In particular, according to an embodiment of the present disclosure, the process described above with reference to the flow diagram can be implemented as a computer software program. For example, an embodiment of the present disclosure includes a computer program product, which includes a computer program carried on a computer-readable medium, and the computer program contains program codes for executing the method shown in the flow diagram. In such an embodiment, the computer program can be downloaded and installed from the network through the communication means 609, or installed from the storage means 608, or installed from the ROM 602. When the computer program is executed by the processing means 601, the above functions defined in the method of the embodiment of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. More specific examples of the computer-readable storage medium can include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium containing or storing a program, which can be used by or in combination with an instruction execution system, apparatus or device. In the present disclosure, the computer-readable signal medium can include a data signal propagated in baseband or as part of a carrier wave, in which computer-readable program codes are carried. This propagated data signal can take many forms, including but not limited to an electromagnetic signal, an optical signal or any suitable combination of the above. The computer-readable signal medium can also be any computer-readable medium other than the computer-readable storage medium, which can send, propagate or transmit a program for use by or in connection with an instruction execution system, apparatus or device. The program codes contained in the computer-readable medium can be transmitted by any suitable medium, including but not limited to: wires, optical cables, RF (radio frequency) and the like, or any suitable combination of the above.

The above computer-readable medium can be included in the above electronic device; or it can exist alone without being assembled into the electronic device.

The above computer-readable medium carries one or more programs, which, when executed by the electronic device, cause the electronic device to perform the method shown in the above embodiments.

Computer program codes for performing the operations of the present disclosure can be written in one or more programming languages or combinations thereof, including object-oriented programming languages such as Java, Smalltalk, C++, and conventional procedural programming languages such as “C” or similar programming languages. The program codes can be completely executed on a user computer, partially executed on the user computer, executed as an independent software package, partially executed on the user computer and partially executed on a remote computer, or completely executed on the remote computer or a server. In the case of involving a remote computer, the remote computer can be connected to a user computer through any kind of network, including a Local Area Network (LAN) or a Wide Area Network (WAN), or can be connected to an external computer (for example, by using an internet service provider).

The flow diagrams and block diagrams in the drawings illustrate the architecture, functions and operations of possible implementations of the system, the method and the computer program product according to various embodiments of the present disclosure. In this regard, each block in the flow diagrams or block diagrams can represent a module, a program segment, or a portion of codes that contains one or more executable instructions for implementing specified logical functions. It should also be noted that in some alternative implementations, the functions noted in the blocks can occur in a different order than those noted in the drawings. For example, two blocks shown in succession can actually be executed substantially in parallel, and they can sometimes be executed in the reverse order, depending on the functions involved. It should also be noted that each or a combination of blocks in the block diagrams and/or flow diagrams can be implemented by a dedicated hardware-based system that performs specified functions or operations, or by a combination of dedicated hardware and computer instructions.

The involved units described in the embodiments of the present disclosure can be implemented by software or hardware. The name of the unit does not constitute the limitation of the unit itself in some cases. For example, the first acquisition unit can also be described as “a unit of acquiring at least two Internet protocol addresses”.

The functions described above herein can be at least partially performed by one or more hardware logic components. For example, without limitation, exemplary types of hardware logic components that can be used include: a Field Programmable Gate Array (FPGA), an Application Specific Integrated Circuit (ASIC), an Application Specific Standard Product (ASSP), a System on Chip (SOC), a Complex Programmable Logic Device (CPLD) and so on.

The present application also provides a computer-readable storage medium, in which computer-executable instructions are stored, and when executed by a processor, implement the technical solution of the application rendering method in any one of the above embodiments. Its implementation principle and beneficial effects are similar to those of the application rendering method. Please refer to the implementation principle and beneficial effects of the application rendering method, which will not be described here.

In the context of the present disclosure, a machine-readable medium can be a tangible medium that can contain or store a program for use by or in connection with an instruction execution system, apparatus or device. The machine-readable medium can be a machine-readable signal medium or a machine-readable storage medium. The machine-readable medium can include, but is not limited to, an electronic, magnetic, optical, electromagnetic, infrared, or semiconductor system, apparatus or device, or any suitable combination of the above. More specific examples of the machine-readable storage medium can include an electrical connection with one or more wires, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The present application also provides a computer program product, including a computer program which, when executed by a processor, implements the technical solution of the application rendering method in any one of the above embodiments. Its implementation principle and beneficial effects are similar to those of the application rendering method, so please refer to the implementation principle and beneficial effects of the application rendering method, which will not be described here.

According to one or more embodiments of the present disclosure, the adjusting the priority corresponding to the focused application to be higher than the priorities corresponding to all the non-focused applications includes: if the priorities of the respective non-focused applications do not include the highest priority, determining any priority higher than the priorities of all the non-focused applications as the target priority, and adjusting the priority of the focused application as the target priority; if the priorities of the respective non-focused applications include the highest priority and the priority of the focused application is the highest priority, lowering the priorities of the respective non-focused applications; if the priorities of the respective non-focused applications include the highest priority and the priority of the focused application is not the highest priority, lowering the priorities of the respective non-focused applications, and determining the highest priority as the priority of the focused application.

In a first aspect, according to one or more embodiments of the present disclosure, there is provided an application rendering method applied to an electronic device which includes a graphics processor, the method comprising: when it is detected that a focused application in a display interface is operated, judging whether there are non-focused applications displayed in the same interface in the display interface; if there are the non-focused applications in the display interface, determining the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue are preferentially executed by the graphics processor; if the priority of the rendering instruction queue of the focused application is not higher than the priorities of the rendering instruction queues of the non-focused applications, adjusting the priority corresponding to the focused application to be higher than the priorities corresponding to all the non-focused applications; transmitting the rendering instructions in the rendering instruction queue of the focused application to the graphics processor according to the adjusted target priority, so that the graphics processor preferentially executes the rendering instructions of the focused application according to the target priority.

According to one or more embodiments of the present disclosure, the graphics processor maintains a plurality of execution queues, and the priorities of the execution queues are corresponding to or consistent with those of the rendering instruction queues, and the execution queues are configured for storing rendering instructions in the rendering instruction queues with corresponding priorities; accordingly, the transmitting the rendering instructions in the rendering instruction queue of the focused application to the graphics processor according to the adjusted target priority, so that the graphics processor preferentially executes the rendering instructions of the focused application according to the target priority comprises: transmitting the rendering instructions in the rendering instruction queue of the focused application to the execution queue corresponding to the target priority. so that the graphics processor preferentially executes the rendering instructions in the execution queue corresponding to the target priority.

According to one or more embodiments of the present disclosure, after the adjusting the priority corresponding to the focused application to be higher than the priorities corresponding to all the non-focused applications, the method further comprises: detecting whether there is an unexecuted rendering instruction of the rendering instruction queue of the focused application remaining in the corresponding original execution queue before priority adjustment of the rendering instruction queue of the focused application; if there is no unexecuted rendering instruction of the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

According to one or more embodiments of the present disclosure, the method further comprises: if there is an unexecuted rendering instruction of the rendering instruction queue of the focused application remaining in the original execution queue, adding a barrier identification in the rendering instruction queue of the focused application; acquiring an identification of the rendering instruction remaining in the original execution queue according to the barrier identification, and suspending sending of the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and continuing transmitting the rendering instructions in the rendering instruction queue of the focused application to the execution queue corresponding to the target priority; wherein the barrier identification is associated with the identification of the rendering instruction remaining in the original execution queue.

According to one or more embodiments of the present disclosure, the barrier identification comprises a first barrier identification and a second barrier identification; the first barrier identification and the second barrier identification are located at the head of the rendering instruction queue of the focused application; wherein the first barrier identification is configured for instructing to acquire the identification of the rendering instruction remaining in the original execution queue and suspending the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released; wherein the second barrier identification is associated with the identification of the remaining rendering instruction and is configured for instructing to suspend the step of transmitting the rendering instructions in the rendering instruction queue of the focused application to the execution queue corresponding to the target priority; the second barrier identification is released after the execution of the remaining rendering instruction is ended, and the step of transmitting the rendering instructions in the rendering instruction queue of the focused application to the execution queue corresponding to the target priority continues.

According to one or more embodiments of the present disclosure, the adjusting the priority corresponding to the focused application to be higher than the priorities corresponding to all the non-focused applications comprises:
if the priorities of the respective non-focused applications do not include the highest priority, determining any priority higher than the priorities of all the non-focused applications as the target priority, and adjusting the priority of the focused application as the target priority; if the priorities of the respective non-focused applications include the highest priority and the priority of the focused application is the highest priority, lowering the priorities of the respective non-focused applications; if the priorities of the respective non-focused applications include the highest priority and the priority of the focused application is not the highest priority, lowering the priorities of the respective non-focused applications, and determining the highest priority as the priority of the focused application.

In a second aspect, according to one or more embodiments of the present disclosure, there is provided an application rendering device applied to an electronic device which comprises a graphics processor, the application rendering device comprising: an application judgement module for judging, when it is detected that a focused application in a display interface is operated, whether there are non-focused applications displayed in the same interface in the display interface; a priority determination module for determining, if there are non-focused applications in the display interface, the priorities of rendering instruction queues corresponding to the focused application and the respective non-focused applications, wherein the rendering instruction queues are configured for storing the rendering instructions corresponding to the applications, and a higher priority indicates that the rendering instructions in the corresponding rendering instruction queue are preferentially executed by the graphics processor; a priority adjustment module for adjusting, if the priority of the rendering instruction queue of the focused application is not higher than the priorities of the rendering instruction queues of the non-focused applications, the priority corresponding to the focused application to be higher than the priorities corresponding to all the non-focused applications; an instruction sending module for transmitting the rendering instructions in the rendering instruction queue of the focused application to the graphics processor according to the adjusted target priority, so that the graphics processor preferentially executes the rendering instructions of the focused application according to the target priority.

According to one or more embodiments of the present disclosure, the graphics processor maintains a plurality of execution queues, and the priorities of the execution queues are corresponding to and consistent with those of the rendering instruction queues, and the execution queues are configured for storing rendering instructions in the rendering instruction queues with corresponding priorities; an instruction sending module for transmitting the rendering instructions in the rendering instruction queue of the focused application to the execution queue corresponding to the target priority, so that the graphics processor preferentially executes the rendering instructions in the execution queue corresponding to the target priority.

According to one or more embodiments of the present disclosure, the application rendering device further comprises: an instruction processing module. The instruction processing module is specifically configured for detecting whether there is an unexecuted rendering instruction of the rendering instruction queue of the focused application remaining in the corresponding original execution queue before priority adjustment of the rendering instruction queue of the focused application; if there is no unexecuted rendering instruction in the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

According to one or more embodiments of the present disclosure, the instruction processing module is further configured for adding a barrier identification in the rendering instruction queue of the focused application if there is an unexecuted rendering instruction of the rendering instruction queue of the focused application remaining in the original execution queue; acquiring an identification of the rendering instruction remaining in the original execution queue according to the barrier identification, and suspending sending of the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and continuing transmitting the rendering instructions in the rendering instruction queue of the focused application to the execution queue corresponding to the target priority; wherein the barrier identification is associated with the identification of the rendering instruction remaining in the original execution queue.

According to one or more embodiments of the present disclosure, the barrier identification includes a first barrier identification and a second barrier identification; the first barrier identification and the second barrier identification are located at the head of the rendering instruction queue of the focused application; wherein the first barrier identification is configured for instructing to acquire the identification of the rendering instruction remaining in the original execution queue and suspending the step of transmitting the rendering instructions in the rendering instruction queue of the focused application to the execution queue corresponding to the target priority. After the step of adjusting the priority corresponding to the focused application to be higher than the priorities corresponding to all the non-focused applications is ended, the first barrier identification is released; wherein the second barrier identification is associated with the identification of the remaining rendering instruction and is configured for instructing to suspend the step of transmitting the rendering instructions in the rendering instruction queue of the focused application to the execution queue corresponding to the target priority. The second barrier identification is released after the execution of the remaining rendering instruction is ended, and the step of transmitting the rendering instructions in the rendering instruction queue of the focused application to the execution queue corresponding to the target priority continues.

According to one or more embodiments of the present disclosure, the priority adjustment module is specifically configured for determining, if the priorities of the respective non-focused applications do not include the highest priority, any priority higher than the priorities of all the non-focused applications as the target priority, and adjusting the priority of the focused application as the target priority; if the priorities of the respective non-focused applications include the highest priority and the priority of the focused application is the highest priority, lowering the priorities of the respective non-focused applications; if the priorities of the respective non-focused applications include the highest priority and the priority of the focused application is not the highest priority, lowering the priorities of the respective non-focused applications, and determining the highest priority as the priority of the focused application.

In a third aspect, according to one or more embodiments of the present disclosure, there is provided an electronic device including at least one processor and a memory;
the memory stores computer-executable instructions;
the at least one processor executes the computer-executed instructions stored in the memory, so that the at least one processor executes the application rendering method according to the above-mentioned first aspect and various possible designs of the first aspect.

In a fourth aspect, according to one or more embodiments of the present disclosure, there is provided a computer-readable storage medium, in which computer-executable instructions are stored, and when executed by a processor, implement the application rendering method according to the above-mentioned first aspect and various possible designs of the first aspect.

The above description is only the preferred embodiments of the present disclosure and the explanation of the applied technical principles. It should be understood by those skilled in the art that the disclosure scope involved in the present disclosure is not limited to the technical solution formed by the specific combination of the above technical features, but also covers other technical solution formed by any combination of the above technical features or their equivalent features without departing from the above disclosure concept, for example, a technical solution formed by the mutual replacement of the above features with the technical features with similar functions disclosed in (but not limited to) the present disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of an individual embodiment can also be combined in a single embodiment. On the contrary, various features described in the context of a single embodiment can also be implemented in multiple embodiments individually or in any suitable sub-combination.

Although the present subject matter has been described in language specific to structural features and/or methodological logical actions, it should be understood that the subject matter defined in the appended claims is not necessarily limited to the specific features or actions described above. On the contrary, the specific features and actions described above are only exemplary forms of implementing the claims.

What is claimed is:

1. An application rendering method, applied to an electronic device which comprises a graphics processor, the method comprising:
in response to detecting that a focused application in a display interface is operated, judging whether there are non-focused applications displayed in the same display interface;
if there are the non-focused applications in the display interface, determining priorities of rendering instruction queues corresponding to the focused application and the respective non-focused applications, wherein the rendering instruction queues are configured for storing rendering instructions corresponding to the applications, and a higher priority indicates that the rendering instructions in the corresponding rendering instruction queue are preferentially executed by the graphics processor;
if the priority of the rendering instruction queue of the focused application is not higher than the priorities of the rendering instruction queues of the non-focused applications, adjusting the priority corresponding to the focused application to be a target priority higher than the priorities corresponding to all the non-focused applications;
transmitting the rendering instructions in the rendering instruction queue of the focused application to the graphics processor according to the adjusted target priority, so that the graphics processor preferentially executes the rendering instructions of the focused application according to the target priority.

2. The method according to claim 1, wherein the graphics processor maintains a plurality of execution queues, and the priorities of the execution queues correspond to and are consistent with those of the rendering instruction queues, and the execution queues are configured for storing the rendering instructions in the rendering instruction queues with corresponding priorities;
accordingly, the transmitting the rendering instructions in the rendering instruction queue of the focused application to the graphics processor according to the adjusted target priority, so that the graphics processor preferentially executes the rendering instructions of the focused application according to the target priority comprises:
transmitting the rendering instructions in the rendering instruction queue of the focused application to the execution queue corresponding to the target priority, so that the graphics processor preferentially executes the rendering instructions in the execution queue corresponding to the target priority.

3. The method according to claim 2, wherein after the adjusting the priority corresponding to the focused application to be higher than the priorities corresponding to all the non-focused applications, the method further comprises:
detecting whether there is an unexecuted rendering instruction of the rendering instruction queue of the focused application remaining in a corresponding original execution queue before priority adjustment of the rendering instruction queue for the focused application;
if there is no unexecuted rendering instruction of the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

4. The method according to claim 3, wherein, the method further comprises:
if there is an unexecuted rendering instruction of the rendering instruction queue of the focused application remaining in the original execution queue, adding a barrier identification in the rendering instruction queue of the focused application;
acquiring an identification of the rendering instruction remaining in the original execution queue according to the barrier identification, and suspending transmitting the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and continuing transmitting the rendering instructions in the rendering instruction queue of the focused application to the execution queue corresponding to the target priority; wherein the barrier identification is associated with the identification of the rendering instruction remaining in the original execution queue.

5. The method according to claim 4, wherein the barrier identification comprises a first barrier identification and a second barrier identification; the first barrier identification and the second barrier identification are located at the head of the rendering instruction queue of the focused application;
wherein the first barrier identification is configured for instructing to acquire the identification of the rendering instruction remaining in the original execution queue and suspend the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released;
wherein the second barrier identification is associated with the identification of the remaining rendering instruction and is configured for instructing to suspend the step of transmitting the rendering instructions in the rendering instruction queue of the focused application to the execution queue corresponding to the target priority; after the execution of the remaining rendering instruction is completed, the second barrier identification is released, and the step of transmitting the rendering instructions in the rendering instruction queue of the focused application to the execution queue corresponding to the target priority continues.

6. The method according to claim 1, wherein the adjusting the priority corresponding to the focused application to be higher than the priorities corresponding to all the non-focused applications comprises:
if the priorities of the respective non-focused applications do not comprise the highest priority, determining any priority higher than the priorities of all the non-focused applications as the target priority, and adjusting the priority of the focused application as the target priority;
if the priorities of the respective non-focused applications comprise the highest priority and the priority of the focused application is the highest priority, lowering the priorities of the respective non-focused applications;
if the priorities of the respective non-focused applications comprise the highest priority and the priority of the focused application is not the highest priority, lowering the priorities of the respective non-focused applications, and determining the highest priority as the priority of the focused application.

7. The method according to claim 2, wherein the adjusting the priority corresponding to the focused application to be higher than the priorities corresponding to all the non-focused applications comprises:
if the priorities of the respective non-focused applications do not comprise the highest priority, determining any priority higher than the priorities of all the non-focused applications as the target priority, and adjusting the priority of the focused application as the target priority;
if the priorities of the respective non-focused applications comprise the highest priority and the priority of the focused application is the highest priority, lowering the priorities of the respective non-focused applications;
if the priorities of the respective non-focused applications comprise the highest priority and the priority of the focused application is not the highest priority, lowering the priorities of the respective non-focused applications, and determining the highest priority as the priority of the focused application.

8. The method according to claim 3, wherein the adjusting the priority corresponding to the focused application to be higher than the priorities corresponding to all the non-focused applications comprises:
if the priorities of the respective non-focused applications do not comprise the highest priority, determining any priority higher than the priorities of all the non-focused applications as the target priority, and adjusting the priority of the focused application as the target priority;
if the priorities of the respective non-focused applications comprise the highest priority and the priority of the focused application is the highest priority, lowering the priorities of the respective non-focused applications;
if the priorities of the respective non-focused applications comprise the highest priority and the priority of the focused application is not the highest priority, lowering the priorities of the respective non-focused applications, and determining the highest priority as the priority of the focused application.

9. An electronic device, comprising: a processor and a memory;
the memory stores computer-executable instructions;
the processor executes the computer-executable instructions stored in the memory, so that the processor executes an application rendering method comprising:
in response to detecting that a focused application in a display interface is operated, judging whether there are non-focused applications displayed in the same display interface;
if there are the non-focused applications in the display interface, determining priorities of rendering instruction queues corresponding to the focused application and the respective non-focused applications, wherein the rendering instruction queues are configured for storing rendering instructions corresponding to the applications, and a higher priority indicates that the rendering instructions in the corresponding rendering instruction queue are preferentially executed by the graphics processor;
if the priority of the rendering instruction queue of the focused application is not higher than the priorities of the rendering instruction queues of the non-focused applications, adjusting the priority corresponding to the focused application to be a target priority higher than the priorities corresponding to all the non-focused applications;
transmitting the rendering instructions in the rendering instruction queue of the focused application to a graphics processor of the electronic device according to the adjusted target priority, so that the graphics processor preferentially executes the rendering instructions of the focused application according to the target priority.

10. The electronic device according to claim 9, wherein the graphics processor maintains a plurality of execution queues, and the priorities of the execution queues correspond to and are consistent with those of the rendering instruction queues, and the execution queues are configured for storing the rendering instructions in the rendering instruction queues with corresponding priorities;
accordingly, the transmitting the rendering instructions in the rendering instruction queue of the focused application to the graphics processor according to the adjusted target priority, so that the graphics processor preferentially executes the rendering instructions of the focused application according to the target priority comprises:
transmitting the rendering instructions in the rendering instruction queue of the focused application to the execution queue corresponding to the target priority, so that the graphics processor preferentially executes the rendering instructions in the execution queue corresponding to the target priority.

11. The electronic device according to claim 10, wherein after the adjusting the priority corresponding to the focused application to be higher than the priorities corresponding to all the non-focused applications, the method further comprises:
detecting whether there is an unexecuted rendering instruction of the rendering instruction queue of the focused application remaining in a corresponding original execution queue before priority adjustment of the rendering instruction queue for the focused application;
if there is no unexecuted rendering instruction of the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

12. The electronic device according to claim 11, wherein, the method further comprises:
if there is an unexecuted rendering instruction of the rendering instruction queue of the focused application remaining in the original execution queue, adding a barrier identification in the rendering instruction queue of the focused application;
acquiring an identification of the rendering instruction remaining in the original execution queue according to the barrier identification, and suspending transmitting the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and continuing transmitting the rendering instructions in the rendering instruction queue of the focused application to the execution queue corresponding to the target priority; wherein the barrier identification is associated with the identification of the rendering instruction remaining in the original execution queue.

13. The electronic device according to claim 12, wherein the barrier identification comprises a first barrier identification and a second barrier identification; the first barrier identification and the second barrier identification are located at the head of the rendering instruction queue of the focused application;
wherein the first barrier identification is configured for instructing to acquire the identification of the rendering instruction remaining in the original execution queue and suspend the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released;
wherein the second barrier identification is associated with the identification of the remaining rendering instruction and is configured for instructing to suspend the step of transmitting the rendering instructions in the rendering instruction queue of the focused application to the execution queue corresponding to the target priority; after the execution of the remaining rendering instruction is completed, the second barrier identification is released, and the step of transmitting the rendering instructions in the rendering instruction queue of the focused application to the execution queue corresponding to the target priority continues.

14. The electronic device according to claim 9, wherein the adjusting the priority corresponding to the focused application to be higher than the priorities corresponding to all the non-focused applications comprises:
if the priorities of the respective non-focused applications do not comprise the highest priority, determining any priority higher than the priorities of all the non-focused applications as the target priority, and adjusting the priority of the focused application as the target priority;
if the priorities of the respective non-focused applications comprise the highest priority and the priority of the focused application is the highest priority, lowering the priorities of the respective non-focused applications;
if the priorities of the respective non-focused applications comprise the highest priority and the priority of the focused application is not the highest priority, lowering the priorities of the respective non-focused applications, and determining the highest priority as the priority of the focused application.

15. The electronic device according to claim 9, wherein the electronic device includes at least one of a mobile phone, an extended reality device or a virtual reality device.

16. A non-transitory computer-readable storage medium, wherein the computer-executable instructions are stored in the computer-readable storage medium, and when executed by a processor, implement the application rendering method applied to an electronic device which comprises a graphics processor, the method comprising:
in response to detecting that a focused application in a display interface is operated, judging whether there are non-focused applications displayed in the same display interface;
if there are the non-focused applications in the display interface, determining priorities of rendering instruction queues corresponding to the focused application and the respective non-focused applications, wherein the rendering instruction queues are configured for storing rendering instructions corresponding to the applications, and a higher priority indicates that the rendering instructions in the corresponding rendering instruction queue are preferentially executed by the graphics processor;
if the priority of the rendering instruction queue of the focused application is not higher than the priorities of the rendering instruction queues of the non-focused applications, adjusting the priority corresponding to the focused application to be a target priority higher than the priorities corresponding to all the non-focused applications;
transmitting the rendering instructions in the rendering instruction queue of the focused application to the graphics processor according to the adjusted target priority, so that the graphics processor preferentially executes the rendering instructions of the focused application according to the target priority.

17. The non-transitory computer-readable storage medium according to claim 16, wherein the graphics processor maintains a plurality of execution queues, and the priorities of the execution queues correspond to and are consistent with those of the rendering instruction queues, and the execution queues are configured for storing the rendering instructions in the rendering instruction queues with corresponding priorities;
accordingly, the transmitting the rendering instructions in the rendering instruction queue of the focused application to the graphics processor according to the adjusted target priority, so that the graphics processor preferentially executes the rendering instructions of the focused application according to the target priority comprises:
transmitting the rendering instructions in the rendering instruction queue of the focused application to the execution queue corresponding to the target priority, so that the graphics processor preferentially executes the rendering instructions in the execution queue corresponding to the target priority.

18. The non-transitory computer-readable storage medium according to claim 17, wherein after the adjusting the priority corresponding to the focused application to be higher than the priorities corresponding to all the non-focused applications, the method further comprises:
detecting whether there is an unexecuted rendering instruction of the rendering instruction queue of the focused application remaining in a corresponding original execution queue before priority adjustment of the rendering instruction queue for the focused application;
if there is no unexecuted rendering instruction of the rendering instruction queue of the focused application remaining in the original execution queue, transmitting the rendering instructions in the rendering instruction queue of the focused application to the execution queue corresponding to the target priority, so that the graphics processor preferentially executes the rendering instructions of the focused application according to the target priority.

19. The non-transitory computer-readable storage medium according to claim 18, wherein, the method further comprises:
if there is an unexecuted rendering instruction of the rendering instruction queue of the focused application remaining in the original execution queue, adding a barrier identification in the rendering instruction queue of the focused application;
acquiring an identification of the rendering instruction remaining in the original execution queue according to the barrier identification, and suspending transmitting the rendering instructions in the rendering instruction queue of the focused application to the execution queue corresponding to the target priority until the step of adjusting the priority corresponding to the focused application to be higher than the priorities corresponding to all the non-focused applications is ended and the execution of the rendering instruction remaining in the original execution queue is completed, and continuing transmitting the rendering instructions in the rendering instruction queue of the focused application to the execution queue corresponding to the target priority; wherein the barrier identification is associated with the identification of the rendering instruction remaining in the original execution queue.

20. The non-transitory computer-readable storage medium according to claim 19, wherein the barrier identification comprises a first barrier identification and a second barrier identification; the first barrier identification and the second barrier identification are located at the head of the rendering instruction queue of the focused application;
wherein the first barrier identification is configured for instructing to acquire the identification of the rendering instruction remaining in the original execution queue and suspend the step of transmitting the rendering instructions in the rendering instruction queue of the focused application to the execution queue corresponding to the target priority; after the step of adjusting the priority corresponding to the focused application to be higher than the priorities corresponding to all the non-focused applications is ended, the first barrier identification is released;
wherein the second barrier identification is associated with the identification of the remaining rendering instruction and is configured for instructing to suspend the step of transmitting the rendering instructions in the rendering instruction queue of the focused application to the execution queue corresponding to the target priority; after the execution of the remaining rendering instruction is completed, the second barrier identification is released, and the step of transmitting the rendering instructions in the rendering instruction queue of the focused application to the execution queue corresponding to the target priority continues.
